(19) United States
(12) Patent Application Publication
(10) Pub. No.: US 2025/0029017 A1
(43) Pub. Date: Jan. 23, 2025

(54) INFORMATION PROCESSING DEVICE AND VEHICLE

(71) Applicant: TOYOTA JIDOSHA KABUSHIKI KAISHA, Toyota-shi (JP)

(72) Inventors: Jun HIOKI, Nagakute-shi (JP); Rie MURAI, Chiba-shi (JP); Tomonari YAMAGUCHI, Miyoshi-shi (JP); Fumiyuki KAGARA, Sagamihara-shi (JP); Hirofumi AINO, Kawaguchi-shi (JP)

(73) Assignee: TOYOTA JIDOSHA KABUSHIKI KAISHA, Toyota-shi (JP)

(21) Appl. No.: 18/740,638

(22) Filed: Jun. 12, 2024

(30) Foreign Application Priority Data
Jul. 19, 2023 (JP) 2023-117825

(51) Int. Cl. G06Q 10/02; G06Q 30/04

(52) U.S. Cl. CPC G06Q 10/02; G06Q 30/04

(57) ABSTRACT

The information processing device includes a communication unit that communicates with the vehicle, a control unit that acquires reservation information including a schedule in which the user uses the vehicle and a service option selected as a function in which the user desires to use the vehicle, creates service activation information that is downloaded to the vehicle on the basis of the acquired reservation information to enable a function selected as a service option among one or more functions included in the vehicle, and transmits the created service activation information to the vehicle in accordance with the schedule via the communication unit.

### CROSS-REFERENCE TO RELATED APPLICATION

This application claims priority to Japanese Patent Application No. 2023-117825 filed on Jul. 19, 2023, incorporated herein by reference in its entirety.

### BACKGROUND

### 1. Technical Field

The present disclosure relates to an information processing device and a vehicle.

### 2. Description of Related Art

Japanese Unexamined Patent Application Publication No. 2021-189776 (JP 2021-189776 A) describes a settlement system performing settlement by electronic money used for using car sharing, in which the settlement system outputs information obtained by comparing a fee, relating to a period extension for car sharing in which a vehicle is lent, with a balance of electronic money registered as a settlement method for car sharing.

### SUMMARY

Rental car services and car sharing services, in which cars are used in common among a plurality of users, are in widespread use. In car sharing services, usage fees for rental cars and shared cars are generally set uniformly in accordance with vehicle class, usage period of the vehicle, and so forth. For example, JP 2021-189776 A describes a settlement system in which usage fees for car sharing follow a fee system in which distance fees corresponding to distance, and time fees corresponding to time, are added.

In recent years, diversification and performance enhancement of functions that can be used in vehicles have become advanced. It is assumed that each user who uses a one-time-use vehicle, which is used on a one-time basis by an unspecified number of users in a rental car service, a car sharing service, or the like, will desire to select a function that suits his/her needs from such functions, and use this function on demand.

The technology described in JP 2021-189776 A does not address selectively enabling functions of the vehicle on demand.

It is an object of the present disclosure to allow functions of a vehicle to be selectively enabled on demand.

An information processing device according to the present disclosure includes a communication unit that communicates with a vehicle, and a control unit that acquires reservation information including a schedule for a user to use the vehicle and a service option selected by the user as a function that is desired to be used in the vehicle, downloads the reservation information to the vehicle based on the reservation information that is obtained, so as to create service activation information for enabling the function selected as the service option out of one or more functions included in the vehicle, and transmits the service activation information that is created to the vehicle in accordance with the schedule, via the communication unit.

According to the present disclosure, functions of a vehicle can be selectively enabled on demand.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of an information processing system according to an embodiment of the present disclosure;

FIG. 2 is a block diagram illustrating a configuration of an information processing device according to an embodiment of the present disclosure;

FIG. 3 is a block-diagram illustrating a configuration of a vehicle according to an embodiment of the present disclosure; and

FIG. 4 is a diagram illustrating operations of an information processing system according to an embodiment of the present disclosure.

### DETAILED DESCRIPTION OF EMBODIMENTS

Hereinafter, embodiments of the present disclosure will be described below with reference to the drawings.

In each drawing, the same or corresponding portions are denoted by the same reference signs. In the description of the present embodiment, description of the same or corresponding components will be appropriately omitted or simplified.

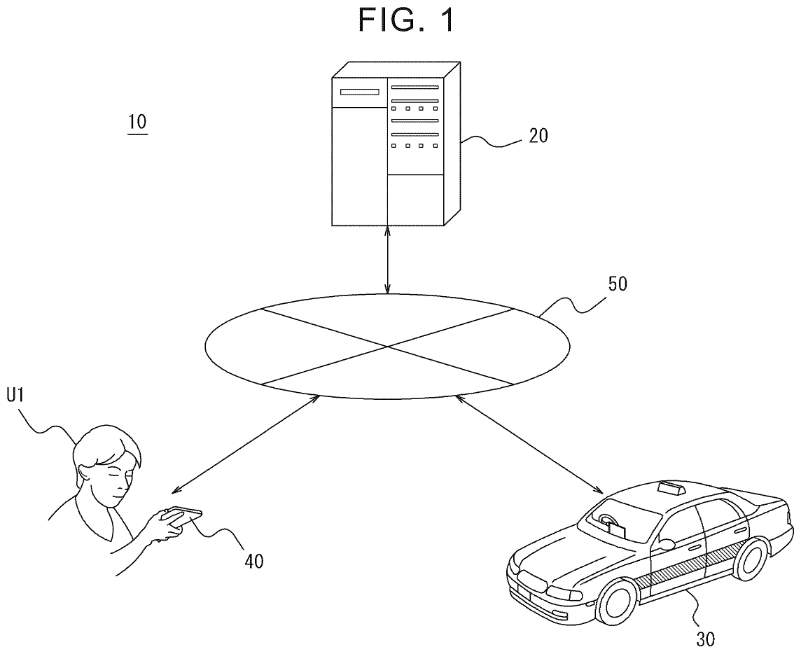

A configuration of the information processing system 10 according to the present embodiment will be described with reference to FIG. 1.

The information processing system 10 includes at least one information processing device 20, at least one vehicle 30, and a user U1 terminal device 40. Note that there may be a plurality of information processing devices 20, a plurality of vehicles 30, and a plurality of terminal devices 40.

The information processing device 20 is capable of communicating with the vehicle 30 and the terminal device 40 via the network 50.

The information processing device 20 is installed in a facility such as a data center. The information processing device 20 is, for example, a server belonging to a cloud computing system or another computing system.

The vehicle 30 is a vehicle of any type, such as a gasoline vehicle, a diesel vehicle, a hydrogen vehicle, an HEV, a PHEV, a BEV, or an FCEV. “HEV” is an abbreviation for hybrid electric vehicle. “PHEV” is an abbreviation for plug-in hybrid electric vehicle. “BEV” is an abbreviation for battery electric vehicle. “FCEV” is an abbreviation for fuel cell electric vehicle.

In the present embodiment, the terminal device 40 is held by a user U1. The terminal device 40 is, for example, a mobile device such as a mobile phone, a smart phone, or a tablet, or a general-purpose terminal such as a PC. PC is an abbreviation for personal computer.

The network 50 includes the Internet, at least one WAN, at least one MAN, or a combination thereof. WAN is an abbreviation for wide area network. MAN is an abbreviation for metropolitan area network. The network 50 may include at least one wireless network, at least one optical network, or a combination thereof. The wireless network is, for example, an ad hoc network, a cellular network, a wireless LAN, a satellite communication network, or a terrestrial microwave network. The term “LAN” is an abbreviation for “local area network”.

The outline of the present embodiment will be described with reference to FIG. 1.

In the present embodiment, the vehicle 30 is a so-called one-time use vehicle such as a rental car or a share car. “One-time use vehicle” means that one or more users use the vehicle on different schedules that do not overlap each other for each user. The vehicle 30 may be a vehicle selected from a plurality of vehicles. Each of the one or more users makes a reservation by specifying a schedule SH including a date and time and/or a period for which the user desires to use the vehicles 30. It is assumed that one or more users include a user U1. For example, the vehicle 30 is used by the user U1 when the user U1 designates a schedule SH1 to reserve the vehicle 30 during the schedule SH1 period P1.

In the present embodiment, the vehicle 30 includes one or more functions F that can be used by each user while riding in the vehicle 30. The function F includes a function which is installed in advance in the vehicle 30 as an application program and becomes available by enabling the application program. Hardware necessary for using the function F is installed in the vehicle 30 in advance. Exemplary such functions F include, but are not limited to, a car navigation function, an electronic fee collection function such as ETC, a restraint safety function, an accident-response function such as a drive recorder, a parking search function, an audio interaction function, a tourism guidance function, and the like.

In the present embodiment, the user U1 who intends to reserve the vehicles 30 accesses any reservation system via the terminal device 40. The user U1 performs login by inputting login information such as a user ID1, a password, and the like to the reservation system. The term “ID” is an abbreviation for identifier. The user U1 inputs, to the reservation system, a reservation information D1 including a schedule SH1 such as a period P1 for which use of the vehicle 30 is desired and a service option OP selected as a function f1 for which use is desired in the vehicle 30, using the terminal device 40. In the present embodiment, the reservation system is constructed on a reservation platform operated by a rental car operator or a share car operator. The reservation system may be constructed on a reservation platform operated by a reservation management business operator.

In the information processing system 10 according to the present embodiment, the information processing device 20 accesses the reservation platform and acquires the reservation information D1. The reservation information D1 includes information indicating the user U1's schedule SH1 using the vehicle 30 and the service option OP selected as the function f1 that the user U1 desires to use in the vehicle 30. The reservation information D1 may include information indicating a user ID1 of the user U1. The information processing device 20 creates the service activation information D2 based on the acquired reservation information D1. The service activation information D2 is information that is downloaded to the vehicle 30 to enable the function f1 selected as the service option OP among the one or more functions F included in the vehicle 30. The information processing device 20 transmits the created service activation information D2 to the vehicles 30 in accordance with the schedule SH1. Upon receiving the service activation information D2 transmitted from the information processing device 20, the vehicle 30 enables the function f1 selected as the service option OP indicated by the service activation information D2 among the one or more functions F. The information processing device 20 calculates a fee for each function f1 enabled in the vehicles 30 during the period P1 of the schedule SH1, and notifies the user U1 of the sum of the calculated fees.

According to the present embodiment, when the user U1 who intends to reserve the vehicle 30 selects the function f1 which is desired to be used when the vehicle 30 is used among the functions F as the service option OP, the user U1 transmits the service activation information D2 to the vehicle 30 in accordance with the schedule SH1 for using the vehicle 30. Then, in the vehicles 30, the function f1 is enabled. Therefore, the function f1 required by the user U1 among the functions F included in the vehicles 30 is selectively enabled on demand. Then, the user U1 obtains the right to use the enabled function f1. That is, according to the present embodiment, it is possible to enable a function necessary for the user for a required time. Further, by calculating the fee for each enabled function and notifying the user of the total calculated fee, the user is not charged for the use fee for the unnecessary function, so that it is possible to use the function in a reasonable manner. That is, according to the present embodiment, it is possible to provide a detailed service according to user-on-demand.

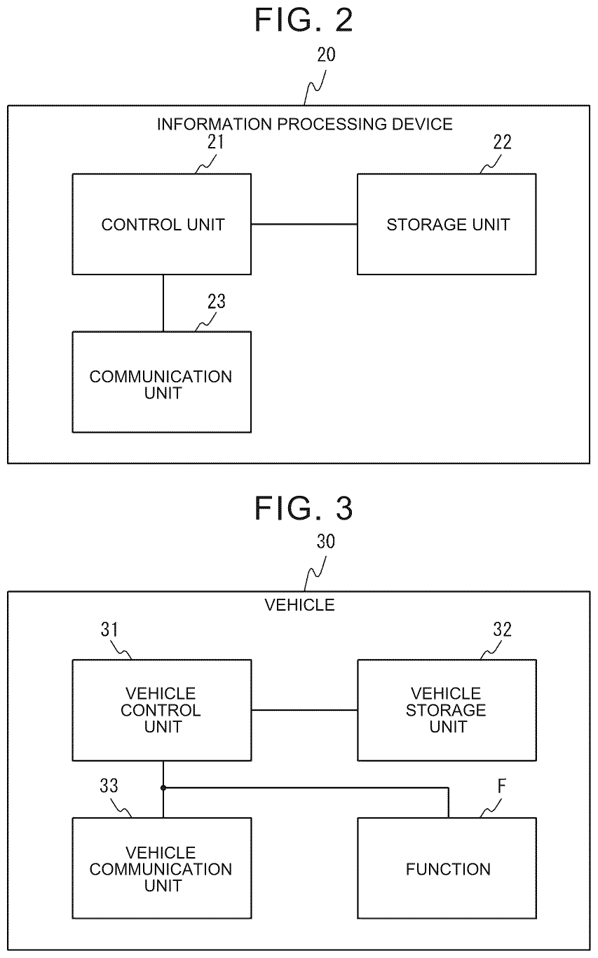

The configuration of the information processing device 20 according to the present embodiment will be described with reference to FIG. 2.

The information processing device 20 includes a control unit 21, a storage unit 22, and a communication unit 23.

The control unit 21 includes at least one processor, at least one programmable circuit, at least one dedicated circuit, or a combination thereof. The processor is a general-purpose processor such as a CPU or a GPU, or a dedicated processor specialized for a specific process. The term “CPU” is an abbreviation for “central processing unit”. The term “GPU” is an abbreviation for “graphics processing unit”. The programmable circuit is, for example, an FPGA. The term “FPGA” is an abbreviation for “field-programmable gate array”. The dedicated circuit is, for example, an ASIC. The term “ASIC” is an abbreviation for “application specific integrated circuit”. The control unit 21 executes processes related to the operation of the information processing device 20 while controlling various units of the information processing device 20.

The storage unit 22 includes at least one semiconductor memory, at least one magnetic memory, at least one optical memory, or a combination of at least two of them. The semiconductor memory is, for example, a RAM or a ROM. The term “RAM” is an abbreviation for “random access memory”. The term “ROM” is an abbreviation for “read-only memory”. The RAM is, for example, an SRAM or a DRAM. The term “SRAM” is an abbreviation for “static random access memory”. The term “DRAM” is an abbreviation for “dynamic random access memory”. The ROM is, for example, an EEPROM. The term “EEPROM” is an abbreviation for “electrically erasable programmable read-only memory”. The storage unit 22 functions as, for example, a main storage device, an auxiliary storage device, or a cache memory. The storage unit 22 stores data used for the operations of the information processing device 20 and data obtained through the operations of the information processing device 20. In the present embodiment, the storage unit 22 may store history information D3. The history information D3 will be described later.

The communication unit 23 includes at least one communication interface. The communication interface is, for example, a LAN interface. The communication unit 23 receives data used for the operation of the information processing device 20 and transmits data obtained by the operation of the information processing device 20. In the present embodiment, the communication unit 23 communicates with the vehicle 30. The communication unit 23 also communicates with the terminal device 40.

The function of the information processing device 20 is realized by executing the information processing program according to the present embodiment by a processor serving as the control unit 21. That is, the functions of the information processing device 20 are realized by software. The information processing program causes the computer to function as the information processing device 20 by causing the computer to execute the operation of the information processing device 20. That is, the computer functions as the information processing device 20 by executing the operation of the information processing device 20 in accordance with the information processing program.

The program can be stored in a non-transitory computer-readable medium. The non-transitory computer-readable medium is, for example, a flash memory, a magnetic recording device, an optical disc, an opto-magnetic recording medium, or a ROM. The distribution of the program is carried out, for example, by selling, transferring, or renting a portable medium such as an SD card, a DVD, or a CD-ROM in which the program is stored. The term “SD” is an abbreviation for “secure digital”. The term “DVD” is an abbreviation for “digital versatile disc”. The term “CD-ROM” is an abbreviation for “compact disc read-only memory”. The program may be stored in the storage of the server and transferred from the server to other computers to distribute the program. The program may be provided as a program product.

The computer temporarily stores the program stored in the portable medium or the program transferred from the server in the main storage device, for example. The computer then causes the processor to read the program stored in the main storage device, and causes the processor to execute processes in accordance with the read program. The computer may read the program directly from the portable medium and execute processes in accordance with the program. The computer may execute the processes in accordance with the received program each time the program is transferred from the server to the computer. The processes may be executed by a so-called ASP service that realizes the function only by execution instruction and result acquisition without transferring the program from the server to the computer. The term “ASP” is an abbreviation for “application service provider”. The program includes information that is used for processing by electronic computers and equivalent to a program. For example, data that is not a direct command to a computer but has the property of defining the process of the computer corresponds to the “data equivalent to a program”.

Part or all of the functions of the information processing device 20 may be realized by a programmable circuit or a dedicated circuit as the control unit 21. That is, some or all of the functions of the information processing device 20 may be realized by hardware.

The configuration of the vehicle 30 according to the embodiment will be described with reference to FIG. 3.

The vehicle 30 includes a vehicle control unit 31, a vehicle storage unit 32, a vehicle communication unit 33, and a function F.

The vehicle control unit 31 includes at least one processor, at least one programmable circuit, at least one dedicated circuit, or a combination thereof. The processor is a general-purpose processor such as a CPU or a GPU, or a dedicated processor specialized for a specific process. The programmable circuit is, for example, an FPGA. The dedicated circuit is, for example, an ASIC. The vehicle control unit 31 executes processing related to the operation of the vehicle 30 while controlling each functional component of the vehicle 30.

The vehicle storage unit 32 includes at least one semiconductor memory, at least one magnetic memory, at least one optical memory, or a combination of at least two of these. The semiconductor memory is, for example, a RAM or a ROM. The RAM is, for example, an SRAM or a DRAM. The ROM is, for example, an EEPROM. The vehicle storage unit 32 functions as, for example, a main storage device, an auxiliary storage device, or a cache memory. The vehicle storage unit 32 stores data used for the operation of the vehicle 30 and data obtained by the operation of the vehicle 30. In the present embodiment, the service activation information D2 downloaded from the information processing device 20 may be stored in the vehicle storage unit 32.

The vehicle communication unit 33 includes at least one communication interface. The communication interface is, for example, a LAN interface. The vehicle communication unit 33 receives data used for the operation of the vehicle 30 and transmits data obtained by the operation of the vehicle 30.

Further, the vehicle 30 is configured by pre-installed hardware and/or a pre-installed application program, and has a function F available to the user. In the present embodiment, the function F is enabled so that the service option OP can be provided to the user. Exemplary such functions F include, but are not limited to, a car navigation function, an electronic fee collection function such as ETC, a restraint safety function, an accident-response function such as a drive recorder, a parking search function, an audio interaction function, a tourism guidance function, and the like.

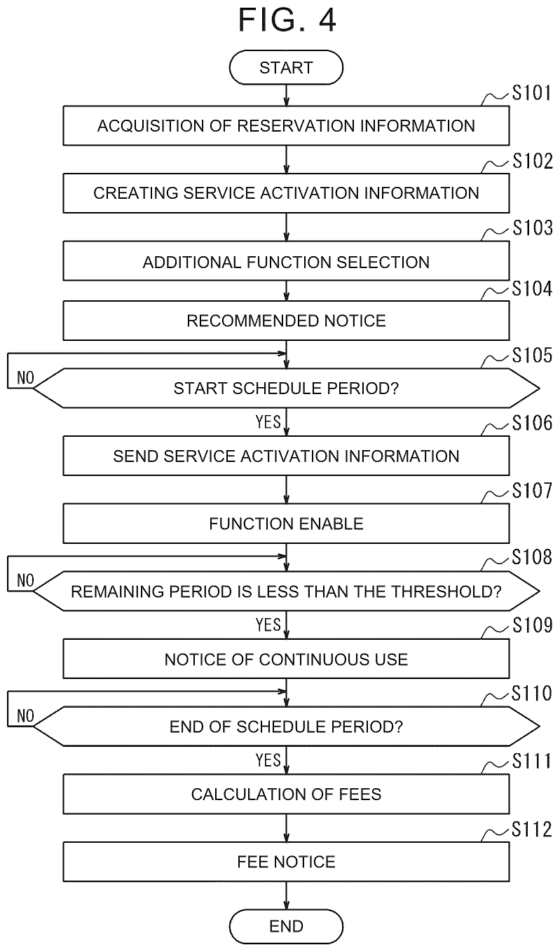

An operation of the information processing system 10 according to the present embodiment will be described with reference to FIG. 4. This operation corresponds to an information processing method according to the present embodiment.

It is assumed that the vehicle 30 is reserved by the user U1 who desires to use the vehicle 30. The reservation of the vehicle 30 may be performed by any procedure. For example, the user U1 logs in to the reservation system by inputting a user ID1, a password, and the like for identifying the user U1 via the terminal device 40, and performs reservation of the vehicles 30. The user U1 inputs, to the terminal device 40, the period P1 as the schedule SH1 desired to be used by the vehicle 30, selects the function f1 desired to be used in the vehicle 30 by the user U1, and inputs the selected function f1 as the service option OP. The entry of the period P1 may be, but is not limited to, an entry in units of hours or days, for example. The terminal device 40 transmits, as the reservation information D1, information indicating the period P1 as the schedule SH1 and the function f1 as the service option OP inputted by the user U1 to the reservation system. The reservation system receives the reservation information D1 and stores it in storage of the reservation system.

In S101, the control unit 21 of the information processing device 20 acquires the reservation information D1. Specifically, the control unit 21 communicates with the reservation system. The reservation information D1 is transmitted from the reservation system to the information processing device 20. The control unit 21 receives the reservation information D1 transmitted from the reservation system via the communication unit 23. The reservation information D1 includes information indicating that the user U1 uses the period P1 using the vehicles 30 as the schedule SH1 and information indicating that the function f1 selected by the user U1 is the service option OP. The reservation information D1 may include information indicating a user U1's user ID1 or an attribute T1 of the user U1.

In S102, the control unit 21 of the information processing device 20 creates the service activation information D2 based on the reservation information D1 acquired by S101. In the present embodiment, the service activation information D2 is information for enabling a function f indicated as a service option OP among one or more functions F in the vehicles 30. The function f shown as a service option OP may include a function f1 selected by the user U1 and additional function f2 described later. When the service activation information D2 is downloaded to the vehicle 30, among the one or more functions F included in the vehicle 30, the function f selected as the service option OP is enabled and becomes available for user U1.

As a modification of the present embodiment, the control unit 21 of the information processing device 20 may select, in addition to the function f1 selected as the service option OP by the user U1, the additional function f2 recommended to the user U1 as the candidates for the function f enabled by the service activation information D2. Then, the control unit 21 may transmit notification N1 for recommending use of the selected additional function f2 to the terminal device 40 of the user U1 via the communication unit 23. Specifically, the control unit 21 may further perform the following S103 and S104 processes.

In S103, the control unit 21 of the information processing device 20 selects an additional function f2 recommended to the user U1. The additional functional f2 may be arbitrarily selected, for example, in the following manner.

As one step of selecting the additional function f2, the control unit 21 of the information processing device 20 searches for and acquires the history information D3 indicating the driving record of the user U1 based on the user ID1. The control unit 21 selects the additional function f2 based on the acquired history information D3. As an example, it is assumed that the driving record of the user U1 indicated by the history information D3 includes a record of the type of the function used in the vehicles used by the user U1 in the past. The control unit 21 determines the type of the frequently used function used for the user U1 based on the history information D3, and selects a function other than the function f1 as the additional function f2 corresponding to the determined type of the function. Alternatively, the control unit 21 may select, as the additional function f2, a function other than the function f1, which is an upgraded function or a performance-enhanced function among functions of the same type as or similar to the function used by the user U1. In the present embodiment, the history information D3 is stored in the storage unit 22. The history information D3 may be stored in an external storage and referred to by the control unit 21 of the information processing device 20.

As another step of selecting the additional function f2, the control unit 21 of the information processing device 20 may select the additional function f2 using the learned model M. As the learned model M, for example, a learned model M1 may be used in which the user's attribute T is input and a function that is expected to be highly interesting to the user and that has not yet been used by the user is output. As an example, it is assumed that the reservation information D1 acquired by S101 includes, for example, the age, sex, and occupation of the user U1 as the attribute T1 of the user U1. The control unit 21 may select the function outputted from the learned model M1 as an additional function f2 recommended to the user U1 by inputting the attribute T1 of the user U1 included in the reservation information D1 to the learned model M1.

In S104, the control unit 21 of the information processing device 20 transmits, to the terminal device 40 via the communication unit 23, notification N1 for recommending use of the additional function f2 selected by S103. The control unit 21 adds, as a response R1 from the user U1 to the notification N1, the additional function f2 as a function f enabled by the service activation information D2 in addition to the function f1 when a notification indicating the acceptance of the user U1 for use of the additional function f2 is received. On the other hand, the control unit 21 does not add the additional function f2 as the function f enabled by the service activation information D2 when a notification indicating that the user U1 is rejected for use of the additional function f2 is received as the response R1.

According to this modification, in addition to the function selected by the user himself/herself, it is possible to additionally recommend a function determined to be highly interesting or useful for the user. Therefore, the range of service options that can be provided to the user can be widened. That is, it is possible to increase an opportunity for the user to use more functions, and thus the quality of the service is improved.

In S105, the control unit 21 of the information processing device 20 determines whether or not the period P1 of the schedule SH1 indicated by the reservation information D1 has started. When it is determined that the period P1 has started, S106 process is performed. When it is determined that the period P1 has not started, S105 process is performed again after a predetermined period has elapsed.

In S106, the control unit 21 of the information processing device 20 transmits the created service activation information D2 to the vehicles 30 via the communication unit 23. The service activation information D2 may be transmitted at any timing within the period P1 of the schedule SH1. For example, when the control unit 21 detects that the vehicle 30 has been started within the period P1 after the start of the period P1 of the schedule SH1, it transmits a service activation information D2 to the vehicle 30.

In S107, the vehicle control unit 31 of the vehicle 30 performs control to enable the function F of the vehicle 30 when the service activation information D2 transmitted from the information processing device 20 is received via the vehicle communication unit 33. Specifically, the vehicle control unit 31 downloads the received service activation information D2 to the vehicle 30. As a result, the function f that provides the service option OP indicated by the service activation information D2 among the functions F of the vehicles 30 is enabled.

As described above, the information processing device 20 acquires the reservation information D1 including the schedule SH1 in which the user U1 uses the vehicle 30 and the service option OP selected as the function f1 in which the user U1 desires to use the vehicle 30. The information processing device 20 creates the service activation information D2 based on the acquired reservation information D1. When the service activation information D2 is downloaded to the vehicle 30, the function f selected as the service option OP among the one or more functions F included in the vehicle 30 is enabled. In the service activation information D2, as the function f to be enabled in the vehicles 30, in addition to the function f1 selected as the service option OP by the user U1, additional function f2 recommended to the user U1 may be added. The information processing device 20 transmits the service activation information D2 thus created to the vehicles 30 in accordance with the schedule SH1.

According to the present embodiment, when reserving a vehicle, the user can select a function available in the vehicle as a service option. Then, in accordance with the reserved schedule, the function in the vehicle is automatically enabled and becomes available. Therefore, it is possible to selectively enable a function necessary for the user in the vehicle. Further, the user may communicate with the information processing device 20 even while riding on the vehicle so that further functions can be added as service options. In this case, it is possible to enable the necessary service after the ride, and thus it is possible to obtain the service use right on demand during the rental period of the vehicle.

As a modification of the present embodiment, a trial period P2 may be set in the function f of the vehicles 30 enabled in S107. The “trial period P2” is a period in which a usage fee for a certain function is not incurred even when the function is enabled. The trial period P2 may be set to all of the functions f, or may be set to a part of the functions f. The control unit 21 of the information processing device 20 transmits, to the terminal device 40 via the communication unit 23, a notification N2 prompting the continuous use of the function ft in which the trial period P2 is set by the expiration date of the trial period P2. Alternatively, the communication unit 23 of the information processing device 20 further communicates with the in-vehicle terminal device mounted on the vehicle 30. Then, the control unit 21 transmits the notification N2 to the in-vehicle terminal device via the communication unit 23 by the expiration date of the trial period P2. Specifically, the following S108 and S109 processes are performed.

In S108, the control unit 21 of the information processing device 20 determines whether the remaining period P2′ of the trial period P2 is less than the threshold TH. The threshold TH may be any value, but may be arbitrarily set within a value such that the time from the current time to the end time of the trial period P2 is within X minutes, for example, so that the user U1 knows that the trial period P2 will soon end. When it is determined that the remaining period P2′ is less than the threshold TH, S109 process is performed. When it is determined that the remaining period P2′ is equal to or larger than the threshold TH, S108 process is performed again after a predetermined period has elapsed.

In S109, the control unit 21 of the information processing device 20 transmits a notification N2 prompting the continuous use of the function ft to the terminal device 40 via the communication unit 23. Alternatively, the communication unit 23 of the information processing device 20 may further communicate with the in-vehicle terminal device mounted on the vehicle 30, and the control unit 21 may transmit the notification N2 to the in-vehicle terminal device via the communication unit 23. The control unit 21 receives, via the communication unit 23, as a response R2 from the user U1 to the notification N2, information indicating a function f′ selected by the user U1 as a function for which continuous use is desired among the function ft. Based on the received response R2, the control unit 21 performs control for disabling a function f″ other than the function f′ in the function ft. The user U1 may transmit, as a response R2, information indicating a function that does not wish to be used continuously, that is, a function that wishes to be disabled, as a function f″.

According to the present modification, the control unit 21 of the information processing device 20 transmits, to the terminal device 40 or the in-vehicle terminal device via the communication unit 23, a notification N2 prompting the continuous use of the function ft by the expiration date of the trial period P2 set in the function ft. By providing the trial period P2 as described above, the user U1 can use the function to be used for free as a trial. Further, prior to the completion of the trial period P2, the user U1 can select a required function f′ from among the function ft. After the trial period P2 is completed, the function f″ that is not necessary for the user U1 is disabled. Consequently, the user U1 can continue to use only the favorite function f′ for a fee even after the trial period P2 ends. Therefore, the user U1 does not need to pay for the unnecessary function f while using the necessary function f′ for a fee even after the trial period P2 ends. That is, according to the present embodiment, the user can obtain the right to use the necessary service only for a necessary time. Therefore, according to the present modification, it is possible for the user to use a more reasonable vehicle.

In S110, the control unit 21 of the information processing device 20 determines whether or not the period P1 of the schedule SH1 has ended. When it is determined that the period P1 has ended, S111 process is performed. When it is determined that the period P1 has not ended, S110 process is performed again after a predetermined period has elapsed.

In S111, the control unit 21 of the information processing device 20 calculates a fee for each function f enabled in the vehicles 30 during the period P1 of the schedule SH1. Although the fee may be calculated in any manner, the fee per unit time may be set for each function F included in the vehicle 30, and the fee per unit time set for the function f enabled in the period P1 may be multiplied by the time when the function f is activated. When the trial period P2 is set in the function f, the control unit 21 calculates a fee for each function f that has been enabled until the end of the period P1 after the end of the trial period P2. Specifically, the control unit 21 calculates the fee by multiplying the fee per unit time set for the function f′ by the time period during which the function f′ was enabled from the end of the trial period P2 until the end of the period P1.

In S112, the control unit 21 of the information processing device 20 notifies the user U1 of the sum of the fees calculated by S111. For example, the control unit 21 transmits, to the terminal device 40 of the user U1 via the communication unit 23, information indicating the sum of the fees calculated by S111 as the use fee of the service option OP in addition to the use fee of the vehicle 30 in the period P1. The control unit 21 may transmit the total of the calculated fees to the in-vehicle terminal device mounted on the vehicle 30 via the communication unit 23.

According to the present embodiment, a fee for each function enabled in the vehicles 30 during the period P1 of the schedule SH1 is calculated. Therefore, in the case where the addition or deletion of the function in the vehicle is requested in the one-time use vehicle, the requested function can be enabled or disabled, and the corresponding fee variation can be reflected in the payment amount of the user. That is, the user can invalidate the required service and obtain the use right for the required service for the required time, so that the user can use the service in a reasonable manner. As a business operator, hardware necessary for use of the function F is installed in the vehicle 30 in advance, and there is an advantage that the load does not increase in the main embankment system in which the service function can be extended on demand by the user.

As a modification of the present embodiment, the control unit 21 of the information processing device 20 may receive the service activation request RQ from the vehicles 30 and then transmit the service activation information D2 in the schedule SH1 period P1. Specifically, in the above-described S105, the control unit 21 of the information processing device 20 may determine whether or not the period P1 of the schedule SH1 indicated by the reservation information D1 has started, and may further determine whether or not there is a service activation request RQ from the vehicle 30. The service activation request RQ may be transmitted in any manner, but for example, a service activation request RQ may be transmitted from the vehicle 30 to the information processing device 20 by triggering that the vehicle 30 has been started. In S105, when the control unit 21 receives the service activation request RQ transmitted from the vehicles 30 via the communication unit 23, S106 process is performed. The determination as to whether or not there is a service activation request RQ from the vehicle 30 is repeated until the control unit 21 receives the service activation request RQ from the vehicle 30.

According to this modification, it is possible to separately manage the period in which the function f is enabled in the vehicle 30 and the period P1 in which the vehicle 30 is rented. Therefore, for example, in a case where the usage fee of the function f is calculated based on the amount-by-amount basis according to the length of the period in which the function f is enabled, the usage fee can be calculated more accurately.

The present disclosure is not limited to the embodiment described above. For example, blocks shown in the block diagram may be integrated, or one block may be divided. Instead of executing the steps shown in the flowcharts in chronological order according to the description, the steps may be executed in parallel or in a different order, depending on the processing capacities of the devices that execute the steps, or as necessary. Other changes may be made without departing from the scope of the present disclosure.

For example, in S110, the control unit 21 of the information processing device 20 may determine whether a predetermined period has elapsed after the period P1 has started, instead of determining whether the period P1 of the schedule SH1 has ended. When it is determined that the predetermined period has elapsed, the fee may be calculated in S111 and notified to the user U1 in S112. In this way, the user U1 can know the progress of the usage fee of the function f as the usage status of the service option OP while the vehicle 30 is being rented. Therefore, the user U1 can easily plan the use of the function f according to the budget. Therefore, the convenience is further improved.

What is claimed is:

1. An information processing device comprising:
a communication unit that communicates with a vehicle; and
a control unit that acquires reservation information including a schedule for a user to use the vehicle and a service option selected by the user as a function that is desired to be used in the vehicle, downloads the reservation information to the vehicle based on the reservation information that is obtained, so as to create service activation information for enabling the function selected as the service option out of one or more functions included in the vehicle, and transmits the service activation information that is created to the vehicle in accordance with the schedule, via the communication unit.

2. The information processing device according to claim 1, wherein the control unit calculates a fee for each function that is enabled in the vehicle during a period in the schedule, and notifies the user of a total of the fees that is calculated.

3. The information processing device according to claim 1, wherein:
the communication unit further communicates with a terminal device of the user; and
the control unit selects, in addition to the function selected as the service option indicated by the reservation information, an additional function recommended to the user as a candidate for the function enabled by the service activation information, and transmits a notification recommending use of the additional function that is selected, to the terminal device via the communication unit.

4. The information processing device according to claim 1, wherein:
a trial period, in which no fee is incurred even when enabled, is set for the function;
the communication unit further communicates with a terminal device of the user or an in-vehicle terminal device installed in the vehicle; and
the control unit transmits a notification prompting continued use of the function to the terminal device or the in-vehicle terminal device via the communication unit by an end time limit of the trial period.

5. A vehicle comprising:
a vehicle communication unit that communicates with the information processing device according to claim 1; and
a vehicle control unit that receives the service activation information transmitted from the information processing device, via the vehicle communication unit, wherein
the vehicle includes one or more functions that are installed in advance and that are configured to provide the service options by being enabled, and
upon receiving the service activation information, the vehicle control unit performs control to enable, out of the one or more functions, a function providing a service option indicated by the service activation information.
